(19) United States
(12) Patent Application Publication
(10) Pub. No.: US 2013/0146171 A1
(43) Pub. Date: Jun. 13, 2013

(54) Multi-Tube Spoolable Assembly

(71) Applicant: Fiberspar Corporation, New Bedford, MA (US)

(72) Inventors: Peter A. Quigley, Duxbury, MA (US); Michael Feechan, Katy, TX (US)

(73) Assignee: Fiberspar Corporation, New Bedford, MA (US)

(21) Appl. No.: 13/644,821

(22) Filed: Oct. 4, 2012

Related U.S. Application Data
(60) Provisional application No. 61/543,547, filed on Oct. 5, 2011.

(51) Int. Cl. F16L 11/22

(52) U.S. Cl. CPC F16L 11/22
USPC 138/112

(57) ABSTRACT

A multi-tube spoolable assembly has at least two spoolable composite tubes. Each of the tubes has a substantially fluid impervious inner liner, a composite layer enclosing the liner and having high strength fibers, and an outer protective layer enclosing the composite layer the inner liner. The assembly also has a retaining element to mechanically couple the position of the at least two spoolable composite tubes.

### RELATED APPLICATIONS

The current application claims priority to and the benefit of U.S. Provisional Application No. 61/543,547 filed on Oct. 5, 2011, the disclosure of which is hereby incorporated herein by reference in its entirety.

### BACKGROUND

Spoolable tubing, that is tubing capable of being spooled upon a reel, is commonly used in numerous oil well operations. Typical oil well operations include running wire line cable down hole with well tools, working over wells by delivering various chemicals down hole, and performing operations on the interior surface of the drill hole. The tubes used are required to be spoolable so that the tube can be used in conjunction with one well and then transported on a reel to another well location. Steel coiled tubing is typically capable of being spooled because the steel used in the product exhibits high ductility (i.e. the ability to plastically deform).

The present accepted industry standard for steel coiled tube is an A-606 type 4 modified HSLA steel with yield strengths ranging from 70 ksi to 80 ksi. The HSLA steel tubing typically undergoes bending, during the deployment and retrieval of the tubing, over radii significantly less than the minimum bending radii needed for the material to remain in an elastic state. The repeated bending of steel coiled tubing into and out of plastic deformation induces irreparable damage to the steel tube body leading to low-cycle fatigue failure.

The issue of minimum bending radii also must be addressed when using other materials and configurations. For example, a tube or pipe having a diameter of 8 inches will likely require a much greater minimum bending radius to ensure the material remains in an elastic state as compared to the same tube or pipe with a diameter of 4 inches. A larger minimum bending radius generally requires a larger reel that can take up valuable space.

There is a need for an assembly that allows for a greater volume of fluid flow through a single assembly while allowing the assembly to be spooled on a reel smaller than typically required for single tube devices with a similar flow volume capacity.

### SUMMARY

Disclosed is a spoolable assembly that comprises two or more pipes or tubes, for allowing larger flow capacity in a spoolable pipe without the need for larger reels. For example, a spoolable assembly is disclosed where the core spooling dimension does not increase while the flow capacity increases.

In one aspect, a multi-tube spoolable assembly has at least two spoolable composite tubes. Each of the tubes has a substantially fluid impervious inner liner, a composite layer enclosing the liner and having high strength fibers, and an outer protective layer enclosing the composite layer the inner liner. The assembly also has a retaining element to mechanically couple the position of the at least two spoolable composite tubes.

In some embodiments axes of the at least two spoolable composite tubes are parallel. The spoolable composite tubes may be substantially similar, and each may be at least four inches in diameter and may have an inner diameter of at least three inches. In certain embodiments, the at least two spoolable composite tubes may contact each other. In other embodiments, the assembly may have a spoolable cradle which may be disposed between the at least two spoolable composite tubes. The cradle may have a separate cavity for each spoolable composite pipe. In still other embodiments, the retaining element may be fasteners. The retaining element may also be an extrusion, which may be square, rectangular, or circular.

### BRIEF DESCRIPTION OF THE DRAWINGS

FIG. 1A depicts a schematic, cross-sectional end view of a spoolable assembly in accordance with one embodiment of the invention;

FIG. 1B depicts a schematic, cross-sectional end view of a spoolable assembly in accordance with another embodiment of the invention; and

FIG. 1C depicts a schematic, perspective view of an end of a spoolable assembly in accordance with yet another embodiment of the invention.

### DETAILED DESCRIPTION

Disclosed is a multi-tube spoolable assembly that comprises two or more pipes or tubes to enhance the flow capacity of a single spoolable assembly. The pipes or tubes may also be reinforced thermoplastic (RTP), other plastics, or steel. In certain embodiments, hoses may be substituted, or used in combination with, the pipes and/or tubes. While an embodiment with tubes is described in the specification, the tubes may be replaced or complemented with these other structures.

A composite tube may have an inner liner, which may have a low axial strength. The inner liner can serve as a member to resist leakage of internal fluids from within the spoolable tube. In some embodiments, the liner can include a polymer, a thermoset plastic, a thermoplastic, an elastomer, a rubber, a co-polymer, and/or a composite. The composite can include a filled polymer and a nano-composite, a polymer/metallic composite, and/or a metal (e.g., steel, copper, and/or stainless steel). Accordingly, the liner can include one or more of a polyethylene, a cross-linked polyethylene, a polyvinylidene fluoride, a polyamide, polyethylene terphthalate, polyphenylene sulfide and/or a polypropylene, or combinations of these materials, either as distinct layers or as blends, alloys, copolymers, block copolymers or the like. The liner may also contain solid state additives.

In some embodiments, the liner can be formed from a polymer, e.g. a thermoplastic, by extrusion.

The spoolable tube can also include one or more reinforcing layers. In one embodiment, the reinforcing layers can include fibers having at least a partially helical orientation relative to the longitudinal axis of the spoolable tube. The fibers may have a helical orientation between substantially about thirty degrees and substantially about seventy degrees relative to the longitudinal axis of the tube. For example, the fibers may be counterwound with a helical orientation of about ±40°, ±45°, ±50°, ±55°, and/or ±60°. The reinforcing layer may include fibers having multiple, different orientations about the longitudinal axis. Accordingly, the fibers may increase the load carrying strength of the reinforcing layer(s) and thus the overall load carrying strength of the spoolable tube. In another embodiment, the reinforcing layer may carry substantially no axial load carrying strength along the longitudinal axis at a termination.

The reinforcing layer(s) can be formed of a number of plies of fibers, each ply including fibers. In one embodiment, the reinforcing layer(s) can include two plies, which can optionally be counterwound unidirectional plies. The reinforcing layer(s) can include two plies, which can optionally be wound in about equal but opposite helical directions. The reinforcing layer(s) can include three, four, five, six, seven, eight, or more plies of fibers, each ply independently wound in a helical orientation relative to the longitudinal axis. Plies may have a different helical orientation with respect to another ply, or may have the same helical orientation. The reinforcing layer(s) may include plies and/or fibers that have a partially and/or a substantially axial orientation. The reinforcing layer may include plies of fibers with a tape or coating, such as a tape or coating that includes abrasion resistant material or polymer, disposed between each ply, underneath the plies, on the outside of the plies, or optionally disposed between only certain plies. In some embodiments, an abrasion resistant layer is disposed between plies that have a different helical orientation.

Fibers in the reinforcing layer can include structural fibers and/or flexible yarn components. The structural fibers can be formed of graphite, glass, carbon, KEVLAR, aramid, fiberglass, boron, polyester fibers, polyamide, ceramic, inorganic or organic polymer fibers, mineral based fibers such as basalt fibers, metal fibers, and wire. The flexible yarn components, or braiding fibers, graphite, glass, carbon, KEVLAR, aramid, fiberglass, boron, polyester fibers, polyamide, ceramic, inorganic or organic polymer fibers, mineral based fibers such as basalt fibers, metal fibers, and wire. For example, structural and/or flexible fibers can include glass fibers that comprise e-glass, e-cr glass, Advantex®, s-glass, d-glass, borosilicate glass, soda-lime glass or a corrosion resistant glass. The fibers included in the reinforcing layer(s) can be woven, braided, knitted, stitched, circumferentially wound, helically wound, axially oriented, and/or other textile form to provide an orientation as provided herein (e.g., in the exemplary embodiment, with an orientation between substantially about thirty degrees and substantially about seventy degrees relative to the longitudinal axis). The fibers can be biaxially or triaxially braided.

Reinforcing layers contemplated herein may include fibers that are at least partially coated by a matrix, or may include fibers that are embedded within a matrix, or may include a combination. A reinforcing layer may comprise up to about 30% of matrix by volume, up to about 50% of matrix by volume, up to about 70% of matrix by volume, or even up to about 80% or higher by volume.

The matrix material may be a high elongation, high strength, impact resistant polymeric material such as epoxy. Other alternative matrixes include nylon-6, vinyl ester, polyester, polyetherketone, polyphenylene sulfide, polyethylene, polypropylene, thermoplastic urethanes, and hydrocarbons such as waxes or oils. For example, a reinforcing layer may also include a matrix material such as polyethylene, e.g., low density polyethylene, medium density polyethylene, linear low density polyethylene, high density polyethylene, polypropylene, cross-linked polyethylene, polybutylene, polybutadiene, or polyvinylchloride.

A reinforcing layer may further include pigments, plasticizers, flame retardants, water resistant materials, water absorbing materials, hydrocarbon resistant materials, hydrocarbon absorbent materials, permeation resistant materials, permeation facilitating materials, lubricants, fillers, compatibilizing agents, coupling agents such as silane coupling agents, surface modifiers, conductive materials, thermal insulators or other additives, or a combination of these.

In one embodiment, the reinforcing layer(s) includes fibers having a modulus of elasticity of greater than about 5,000,000 psi, and/or a strength greater than about 100,000 psi. In some embodiments, an adhesive can be used to bond the reinforcing layer(s) to the liner. In other embodiments, one or more reinforcing layers are substantially not bonded to one or more of other layers, such as the inner liner, internal pressure barriers, or external layer(s).

The disclosed spoolable tube may include reinforcing and other layers, and other embodiments as disclosed in U.S. Pat. Nos. 5,921,285; 6,016,845; 6,148,866; 6,286,558; 6,357,485; 6,604,550; 6,857,452; and 7,647,948, hereby incorporated by reference in their entireties. For example the disclosed tubes may also comprise an external layer(s) that can provide wear resistance, UV, and impact resistance or thermal insulation, or selectively increase or decrease the permeability. An outer protective layer external to the composite layer may also be provided. The outer protective layer can provide an outer protective surface and an outer wear resistant surface. The outer protective layer can also resist impacts and abrasion. In those aspects of the invention having both a pressure barrier layer and a outer protective layer, the pressure barrier layer is typically sandwiched between the composite layer and the outer protective layer.

The spoolable tubes can also include one or more energy or data conductors that can, for example, be integral with a wall of the spoolable pipe. Accordingly, the conductors can be integral with the inner layer, and reinforcing layer(s), and/or exist between such inner layer and reinforcing layer and/or exist between the reinforcing layer and an optional external layer. In some embodiments, the conductor can extend along the length of the spoolable tube. The conductors can include an electrical guiding medium (e.g., electrical wiring), an optical and/or light guiding medium (e.g., fiber optic cable), a hydraulic power medium (e.g., a high pressure tube or a hydraulic hose), a data conductor, and/or a pneumatic medium (e.g., high pressure tubing or hose).

The disclosed energy conductors can be oriented in at least a partially helical direction relative to a longitudinal axis of the spoolable tube, and/or in an axial direction relative to the longitudinal axis of the spoolable tube. A hydraulic control line embodiment of the conductor can be either formed of a metal, composite, and/or a polymeric material.

In one embodiment, several conductors can power a machine operably coupled to the coiled spoolable tube. For instance, a spoolable tube can include three electrical energy conductors that provide a primary line, a secondary line, and a tertiary line for electrically powering a machine using a three-phase power system.

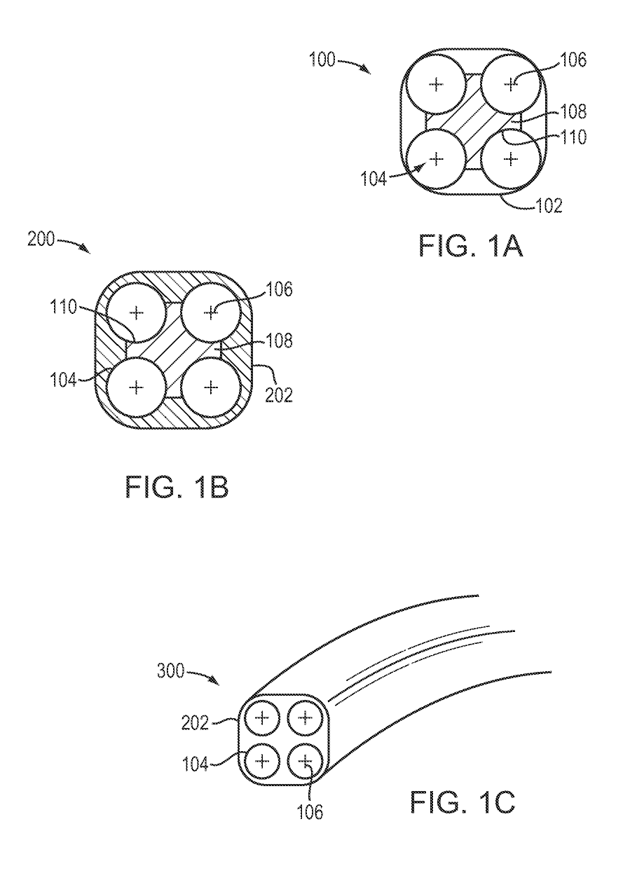

As depicted in FIGS. 1A-1C, a spoolable assembly 100 may include a retaining element 102 to mechanically couple the position of the tubes 104 relative to each other. The retaining element 102 may retain the tubes 104 such that axes 106 of the tubes 104 are substantially parallel. By having the tubes 104 in such a parallel alignment, the stresses, including bending and tensile stresses, are substantially evenly distributed across all the tubes 104.

The retaining element 102 may have many forms. In one embodiment, as depicted in FIG. 1A, the retaining element 102 may be a fastener, such as band around the exterior of the tubes 104. Bands 102 may be placed along the length of the tubes 104 at intervals to help ensure the tubes 104 stay coupled to each other. The bands 102 should be strong enough to remain functional in all environments where the assembly 100 may be introduced, including high temperature, high pressure downhole locations. Examples of bands 102 suitable for these applications include those made of metals, such as thin metals like alloy steel, and non metallic materials, such as reinforced tape, nylon, polypropylene, and other extrudable or moldable thermoplastics.

In some embodiments, the tubes 104 may be banded together without any additional structure, such that the tubes 104 are held in direct contact with each other. In other embodiments, an intermediate structure 108 may be provided to further control the location of the tubes 104 relative to each other, depicted in FIG. 1A as a cradle 108. The cradle 108 may have multiple slots 110 for receiving the tubes 104, and may be formed prior to the introduction of the tubes 104. The cradle 108 may be formed from a variety of materials, including, but not limited to, extrudable or moldable thermoplastics such as polyethylene, polypropylene, or nylon, and metals. These materials may have similar properties to those of the tubes 104 to avoid uneven stress distributions. Alternatively, the cradle 108 may be designed to handle the loads differently, as desired. In some embodiments, fasteners 102 may secure less than all of the tubes 104, such as each tube 104 individually, to the cradle 108.

The cradle 108 may resemble a cross, or a square with cavities 110 at its corners. These cavities 110 may be shaped to complement an exterior shape of the tubes 104 to be placed in them. In some embodiments, the fit between the tubes 104 and the cavities 110 may be an interference fit, firmly securing the tubes 104 in the cradle 108 without additional material. In certain embodiments, the tubes 104 may be bonded to the cradle 108 by mechanical means (e.g., straps, interference fits) or by chemical means (e.g., glues, epoxies or application of heat). The cradle 108 may be relatively short compared to the length of the tubes 104, for example, between approximately one inch and approximately twelve inches long, to allow spooling of the assembly 100. The cradle 108 may also be spoolable. Other embodiments of the cradle may be longer or shorter.

As depicted in FIG. 1B, the tubes 104 and the cradle 108 of spoolable assembly 200 may be extruded to encapsulate the tubes 104 and the cradle 108 in an encapsulant jacket 202. This jacket 202 may be an extrudable or moldable thermoplastic such as polyethylene, polypropylene or nylon, and may be a metal. As with the cradle 108, these materials should be able to withstand the stresses presented by the environments where the spoolable assembly 200 is deployed. These materials may have similar properties as the tubes 104 and the cradle 108, or may be different. Encapsulation may provide a more permanent coupling of the tubes 104, with lesser risk of them becoming disconnected from each other. In certain embodiments, such as in spoolable assembly 300 depicted in FIG. 1C, the tubes 104 may be encapsulated by encapsulant material 202 on all sides, without the cradle 108 between the tubes 104.

The retaining element 102 may couple two or more tubes 104, including three, four, seven, and any other discrete number. These tubes 104 may be substantially similar, such as having similar dimensions, lengths, and materials. For example, in some embodiments, each pipe 104 may have a four and a half inch inner diameter. When four four and a half inch pipes 104 are used, the assembly 100 may have a flow capacity similar to a single eight inch line. However, the core spooling dimension, i.e., the minimum diameter on which the assembly 100 can be safely spooled, is that of the four and a half inch diameter pipe, not the eight inch diameter pipe. Combining tubes 104 in this manner is an effective way to increase flow capacity of a single deployable assembly without increasing the required reel diameter. Tubes 104 of varying dimensions may be used, even within the same assembly, and may provide different flow capacities. The individual tubes 104 may have an inside diameter between approximately three inches and six inches, and the assemblies 100 may have flow capacities equivalent to single tubes having inside diameters of between approximately six inches and twelve inches. The assemblies 100 and the tubes 104 are not limited to these dimensions, and may be greater or less than those described, including tubes 104 with inner diameters of at least approximately three inches or diameters of at least approximately four inches. The assemblies 100, 200, 300 may be square, rectangular, or circular, or any other shape capable of being spooled and deployed in a trench. Other embodiments include a retaining element formed by extrusion, which may be any of the shapes of the assemblies 100, 200, 300.

The assemblies 100, 200, 300 can also include one or more couplings or fittings. For example, such couplings may engage with, be attached to, or in contact with one or more of the internal and external layers of the tubes 104, the retaining element 102, 202, and/or the cradle 108, and may act as a mechanical load transfer device. Separate couplings may be provided for each tube 104, or couplings may be bundled in a single connector. The single connector may still connect to each tube 104 individually. Couplings may engage one or both of the inner liner or the reinforcing layer. Couplings or fittings may be comprised, for example, of metal or a polymer, or both with or without elastomeric seals such as O-rings. In some embodiments, such couplings may allow tubes to be coupled with other metal components. In addition, or alternatively, such couplings or fittings may provide a pressure seal or venting mechanism within or external to the tube. One or more couplings may each independently be in fluid communication with the inner layer and/or in fluid communication with one or more reinforcing layers and/or plies of fibers, or be in fluid communication with one or more of the plurality of channels. In an embodiment, a coupling or fitting includes multi cells or multi fitting so as to match the plurality of channels in a tube.

Such couplings may provide venting, to the atmosphere, of any gasses or fluids that may be present in any of the layers between the external layer and the inner layer, inclusive.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the scope of the disclosed and exemplary systems or methods of the present disclosure.

Although the tubes and assemblies have been described relative to specific embodiments thereof, they are not so limited. Many modifications and variations may become apparent in light of the above teachings. Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

All publications and patents mentioned herein are hereby incorporated by reference in their entirety as if each individual publication or patent was specifically and individually indicated to be incorporated by reference. In case of conflict, the present application, including any definitions herein, will control.

1. A multi-tube spoolable assembly comprising:
at least two spoolable composite tubes, each comprising:
a substantially fluid impervious inner liner;
a composite layer enclosing said liner and comprising high strength fibers; and
an outer protective layer enclosing said composite layer and inner liner; and
a retaining element to mechanically couple the position of the at least two spoolable composite tubes.

2. The assembly of claim 1, wherein axes of the at least two spoolable composite tubes are parallel.

3. The assembly of claim 1, wherein the at least two spoolable composite tubes are substantially similar.

4. The assembly of claim 1, wherein the at least two spoolable composite tubes are each at least four inches in diameter.

5. The assembly of claim 1, wherein the at least two spoolable composite tubes comprise an inner diameter of at least three inches.

6. The assembly of claim 1, wherein the at least two spoolable composite tubes contact each other.

7. The assembly of claim 1 further comprising a spoolable cradle.

8. The assembly of claim 7, wherein the cradle is disposed between the at least two spoolable composite tubes.

9. The assembly of claim 7, wherein the cradle defines a separate cavity for each spoolable composite pipe.

10. The assembly of claim 1, wherein the retaining element comprises fasteners.

11. The assembly of claim 1, wherein the retaining element comprises an extrusion.

12. The assembly of claim 11, wherein the extrusion is a shape selected from the group consisting of square, rectangular, and circular.
